(19) United States
(12) Patent Application Publication
(10) Pub. No.: US 2013/0316735 A1
(43) Pub. Date: Nov. 28, 2013

(54) SYSTEM AND METHODS OF LOCATION BASED SERVICE FOR PEOPLE INTERACTION

(71) Applicants: DAN LI, Sunnvyvale, CA (US); Yongyong Xu, Sunnyvale, CA (US)

(72) Inventors: DAN LI, Sunnvyvale, CA (US); Yongyong Xu, Sunnyvale, CA (US)

(21) Appl. No.: 13/478,117

(22) Filed: May 23, 2012

(51) Int. Cl. H04W 24/00; H04W 12/02

(52) U.S. Cl. 455/456.3

(57) ABSTRACT

System and methods for location based service for people interaction are disclosed. The system and methods allow people not only to connect to their known friends and contacts but also to meet those people unknown or unfamiliar. Direct and intrinsic users' interests can be discovered, categorized and aggregated during daily lives of users and used to improve users' social lives. Additional methods to guard and protect user privacies are also disclosed.

### BACKGROUND

With the fast development of GPS enabled devices, such as smartphones like iPhone, Google Android phones, many location based service (LBS) start to boom. It allows any person who carries a GPS enabled phones able to know the exact location at any time, and then use the mobile device to retrieve relative information nearby.

For example, some services like GPS navigators would show to the user all the nearby restaurants, shopping centers and other facilities or services. So far the majority of the lbs applications are focused on the information around a particular area. Some other services, allows tracking of a people's movement. One example is Google's Latitude which allow one to see the exact location of himself and his friends and also track it. Foursquare is another game company that enables people to play LBS enabled virtual games by allowing users to sign into a particular location and take the virtual ownership.

However, there are still many people who are not tech savvy, so there is a need for those people to make friends with others without proactively or explicitly operations or even the knowledge of LBS services. This patent application discloses system and methods to help people more easily and automatically to build up a better social life and to make friends quicker and easier while exploring the possibilities of LBS services.

### SUMMARY OF INVENTION

In the disclosed system, a user carrying a location based mobile device can have his or her location tracked and recorded at any time. Meanwhile, a secondary channel can be setup to upload his location data to a central server where the central server collects all inputs from all users' locations.

Meanwhile, the server can match any of those two users based on their trait and find out the cross match or intersections for the two users. In other words, any two users can automatically discover how many times they have “met”, or having been onto the same location at almost the same time in the past. The more they met, the more similarities in life style and the more likelihood that they have more common interests and more chance to be friends. This can happen even those two persons have never talked with each other before.

For example, if two persons work inside a same building but within two different companies, they should have shared many things in common, like same or similar transportation, same close or nearby activities, or same restaurants close to the building. Or, if they took a same bus for work, they might have same opinions and complaints about traffic or bus service. Through this system, two persons can be automatically associated as long as there are enough co-incidents or cross-lines and one will never miss any such encounters. Sometimes a person is too shy, lazy or conservative to meet with strangers, then this system is a perfect replacement to help them to meet more people that have many things in common with them because the system does not need the user to do any thing particular, the system will do the work for them automatically.

In some circumstance, one person might have encountered another person he/she admires for long time but does not have the courage to start a conversation, this system provides an excellent way for this kind of situation. When two users encountered enough, the system may automatically connect or introduce them together, avoiding embarrassment for those shy people. In addition, for shy or timid people, the system enables him/her the ability to leave a private message to the target, named or anonymously. And the message could be delivered immediately or after certain time or threshold. In those scenarios, the system acts as a matchmaker, middleman, marriage or dating broker, greatly reduces the mental handicap for people to interact with strangers.

To further protect privacy for the users, messages may be delivered in different ways than traditional messages, such as voicemail or email. That is to say, the message may not been sent to the other party directly, instead, it may be left at the certain location and will only be visible when the other people come back again later. Only when the target come closer to the particular location, he is then able to pick up the message. This way, the system may create or mix a virtual or augmented reality environment within which the online world effectively providers users much more freedom in the development of their human relations then reality or pure online world.

In summary, the system and methods disclosed here open new ways for people to enhance their communications, contacts and relationships to others. In particular, it allows them to meet strangers in different approaches and turn them into closer friends. The system can not only connect people to their known friends, but also connect to those people unknown or unfamiliar to them, and furthermore, it can connect people to others that the system anticipate he/she would might to meet, without extra work from the user.

### BRIEF DESCRIPTION OF THE FIGURE

FIG. 1a is an illustration for finding the crossroad for two people using location aware of mobile devices.

FIG. 1b shows a systematic overview for the system, with multiple mobile devices (applications) update to a central server on its collected location data and servers using the data to perform the match.

FIG. 2 shows a client side application displaying the current track of a user and to follow an other person

FIG. 3 shows how to aggregate life track intersections to calculate the number of encounters between any two persons.

In FIG. 4a, a user can define blind area to protect her privacy.

In FIG. 4b, a user can blur her path to protect her privacy.

FIG. 5 shows a flowchart diagram of matching process that automatically connect two people together inside the system.

### DETAILED DESCRIPTION OF THE INVENTION

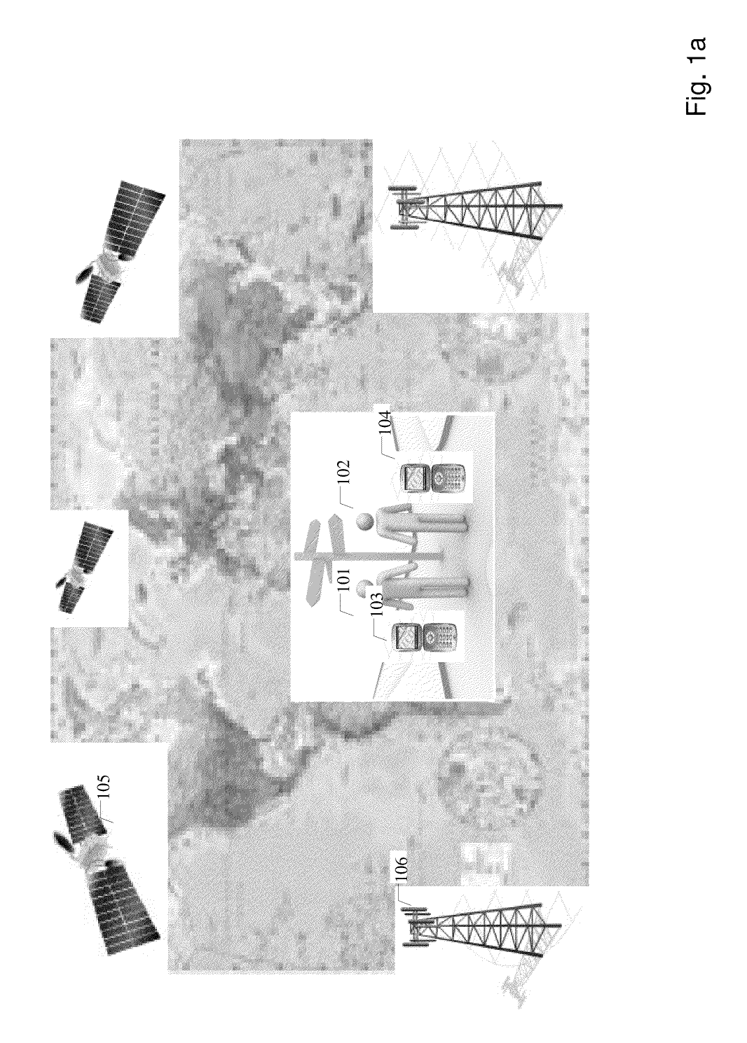

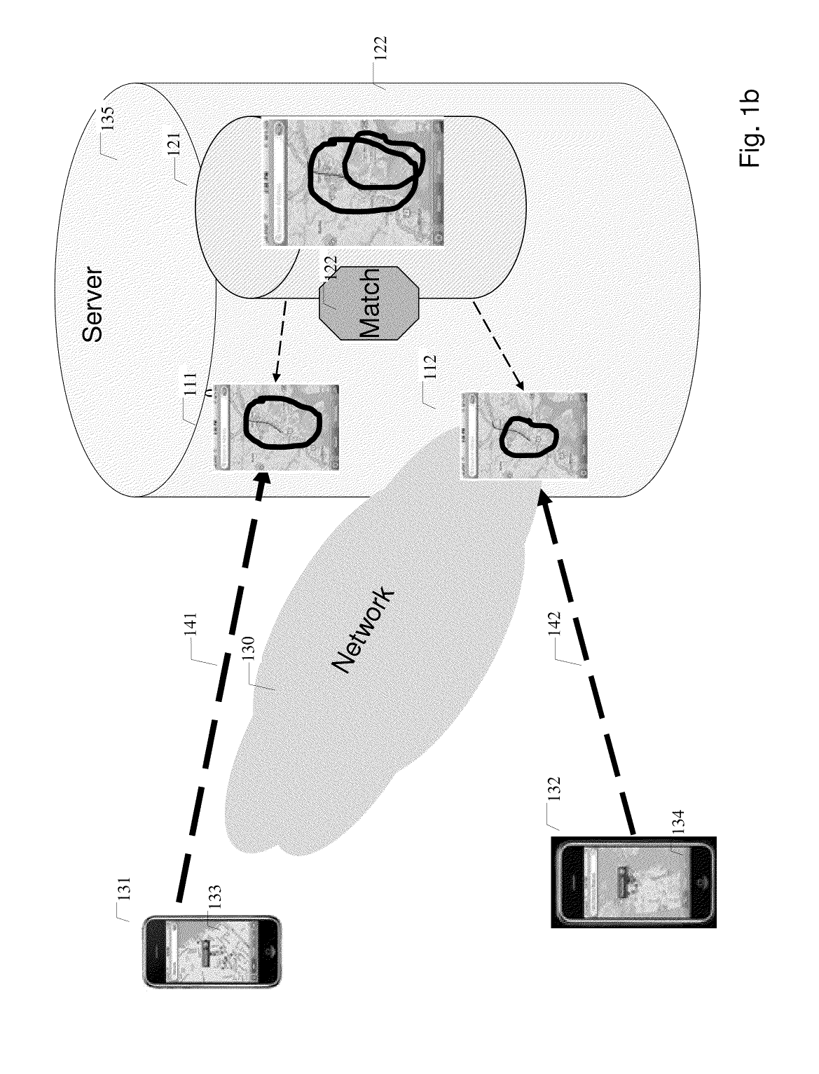

FIG. 1a shows that two people using the system can connect to each other more easily. In this figure, people 101 and 102 each carrying mobile devices 103 and 104, which using location based methods either through GPS satellite 105, cellular tower 106 or other location detection means. When they have met together, mobile software running in the device can record that and use it to connect them.

As shown in FIG. 1b, the system includes both clients 133 or 134 and server 135. A client (133,134) is a mobile application that runs in a mobile device (131,132). A mobile device (131,132) can be a mobile phone, PDA or any other devices that is portable. A server could be a central server, located in a sharable network such as Internet that can be reached by the clients.

After a user installed the mobile application (FIG. 1b, 131,132), the application is then ready to run. The user may login using his/her login name or password to get access to a permanent account. Sometimes, this step can be avoided since some devices may automatically carry a unique identification which can be used by the system to easily identify the user by the id and create an associated account for that user. The main purpose of the application is to monitor where the user is and record such geo-location information. In cases the device is always connected to the network, it can transfer the location data to the central server in real time. If the device is not always connected or temporarily offline, it can cache the data locally and send it later when the device becomes online at a later time.

Typically, the application will record the location data along with the time. The location data can be collected using either built-in GPS, or through the carrier's network location data. Sometimes, when both methods are not available, it may be derived from other means such as location aware of WiFi access points.

Different types of location data may have different precision or accuracy. For instance, GPS data may be the most accurate but may requires better or clear sky view while carrier assisted location data through wireless network can work anywhere, including indoors but may have less precision. In reality, the application may choose a mix of different methods in order to make a balance to gain the best results and user experience for the user.

Other than the location data, the application may also record other info, such as the time, moving speed, orientation, direction of the device, or the people who is carrying the device, with the help of the corresponding sensors inside the device like accelerometers. Other multimedia messages, such as photos can be taken by the built-in camera of the device (if present). Or, sometimes, it may open the microphone to record external sounds and keep them in the record. I

The application can be started automatically after boot and run in the background all the time. Of course, the user may have the option to turn if off temporarily when needed. Other settings, such as the use of microphone and cameras can also be turned off or on in order to protect user privacies. Also, the frequency to sample or collect the geo-location data, and the degree of automation, such as whether or not prompt an explicit dialog for users' approval on each sample data collection, can also be configured. In other words, it allows the user total control for the application's behavior. Of course, for most or average users, when the application is first installed, it shall have some default settings preconfigured. Once user accepts the term of services, the application can then starts the data collecting process.

After the application records the location data (along with other information) and then uploads or sends to the server (FIG. 1b, 141,142), the server can then store that info and uses that info a database (FIG. 1b, 121) and match other users' info in the system (FIG. 1b, 122). The uploading of users' location data can be through a secondary channel without interfering with the main application.

The matching process (FIG. 1b, 122) can be performed automatically, or explicated invoked by the user. One type of matching can be performed upon people's profiles, such as ages, genders, schools attended, companies worked or even nationalities. Moreover, the system can also utilize location data collected during the real time monitoring to achieve different matched results.

Various matching methods can be performed around those geo-location data collected and users. For example, one match could find out other users who are also currently in the same area. After that, the server can send back nearby user's location data to the current user's application and the application can then show those people in a map. This process can be performed in real time if the device is connected and the current user can immediately be aware of how many other people are now in the same area and start to communicate with them.

In additional, the size of the matching area could be defined dynamically. It may depend on the number of people in the whole system. For example, when the system is first launched or when there are not enough users present, the system could define the “same area or nearby” as people within 1 mile distance, or even in the same city. When there are many people online, the distance for the same area could become smaller. In addition, such definition could also vary from location to location, or even from time to time. For instance, when the user is attending a popular conference or tradeshow, the “same area” could mean same room where could be dozens of people already. Either the system could make the choice to control the scope of same area automatically or, the user may choose to change it manually.

Other types of match criteria can also be setup, either by the system automatically or by the user manually. For instance, a user may choose to show his/her friends in the same map and be discoverable even when they are on the same area. In some cases, a user might want to only filter particular users based on genders, interests, or backgrounds. Those criteria can be executed separated or combined together to further filter out the many users if a previous searching or matching result yields too many items.

Once after matching people are discovered, the system could connect them together and begin more interactions. For example, they can chat together, share photos and other information, or make friends. In one scenario, a user can start a chat, or send text or voice message, to another user in the same area, similar to phone calls or short messages. In another scenario, when both users in the same area are close enough to meet face to face, the system may use a special signal to introduce them to each other. For example, the application could play same music together, so both people can immediately know each other. Or, the application could simply speak out “Let me introduce you together . . . ” From then on, they can continue their real conversation face to face and make further connections.

This is just an illustration of what could be done in the system. For people that feel uncomfortable to talk or contact with strangers, the system becomes a bridge to relieve them from such embarrassment and could perform different approaches to help them to get acquainted with each other step by step. This can help even a non social-savvy person since not everyone is a social-guru.

In one embodiment of the present application, when the system finds a match for people in the same area, it may be configured not to introduce them to each other immediately. Instead, the system could simply record such encounters in the database, or prompting the user to start conversation manually. Meanwhile, the system can record the total number of occurrences of any two people in the database, and use it as a signal or counter to measure the relationships between any arbitrary two persons.

Under this approach, any two people, when they have met enough times, or too frequently, above certain threshold, can trigger the system to mark them as now “familiar enough” and ready to be introduced to each other in real life. For example, it is more a much more natural approach to introduce two people together when they both have met in a party for more than 3 times, or 50% more than any other users in the system,

At that time, those two people may no longer be counted as completely strangers from point of view of the system, since they have met enough times and should already have shared many common stuff. For example, they may have attended a same party long time ago, or taken the same bus route last week, lived in the same community, attended same conference, or simply eaten in the same restaurant. There should be much less barriers for them to communicate with each other than two complete strangers. This approach significantly reduces the psychological burden in user interaction for majority of the people, especially for those shy or timid in their social cycles.

Many people are shy or bashful in social connections and may feel uncomfortable with strangers, they are reluctant to communicate face-to-face in real world and prefer to contact in an online or virtual world. For them, in addition to the above mentioned approaches to reduce the anxiety and frustration on meeting or talking with strangers, the system provides additional online or virtual activities for assistance.

For example, if a user discovers another targeted user that he/she wants to approach, the system provides various way for the user to choose. One way is to chat online to the other person to conduct real time chat in the cyber world first. Or, with a mobile device, a SMS short message can also be sent to others. Another approach is to allow a user to send certain virtual items or virtual gifts to the other party to either express themselves or their feelings. For examples, different flowers can be sent to represent different meanings such as respect, admire or even love.

To further make a user feel comfortable in those activities, the system may further allow the user to specify whether the activity he initiated be onymous or anonymous. In named cases, the other party can know immediately who the sender is, while in anonymous cases, the other party may only know that the messages are sent by one of his/her followers, or admirers but not knowing the exact user name, id or real identity of the sender. This may let the sender feel more comfortable if he/she does not want to be recognized (yet) by the other party at that time.

System may also provide different approaches for a user to send a message to the target user. While traditional message sending is to send a message directly to another person, this type of message sending will not deliver the message to the other user, since some people may feel uncomfortable embarrassed to be too blunt, frank, candid or direct. Instead, for instance, the message may be delivered or associated to a particular location and stored to the system. Only when a target user passes by that particular location at a later time can he or she see the message left there. This way allows a user to present his/her wishes or confessions to others in a more introverted way and can be used by introverted people.

In addition, the system can further attach additional attributes to the message sent this way, for example, expire time where the message will expire; or privacy settings, publicity—whether the message is to the general public, private to a particular person, or certain groups; or whether it is anonymous. In certain circumstances, the user may also have the option to revoke, cancel or modify the message later on, even after the message has been sent.

Different types of message or media can be sent or attached as well, such as multimedia message like song, movie or interactive web page. One example would be that, when a target user get close to a particular location, a romantic song may be played in his/her device, reminding him/her that a new message has now been delivered to her. Another example is to play a message after the targeted user appears at a same location for certain times.

Furthermore, the system can also build up connections to external networks including online social networks such as Facebook, Twitter, etc. In this case, if a user has external accounts in external social networks, the system shall be able to connect him to his/her friends in the exterior social networks. For example, the system can automatically notify external messages to the exterior social network whenever the user passed by a certain locations, like his favorite restaurants or recreation centers.

In this the system, a client application running in the device constantly monitors the users' location such as geographical coordinates and other properties through various sensors. It is also an embodiment of the present application for the system to draw and analysis a user's track diagram in real time. In this system, every user may have his/her own track graph as it represents his/her unique “route” every day.

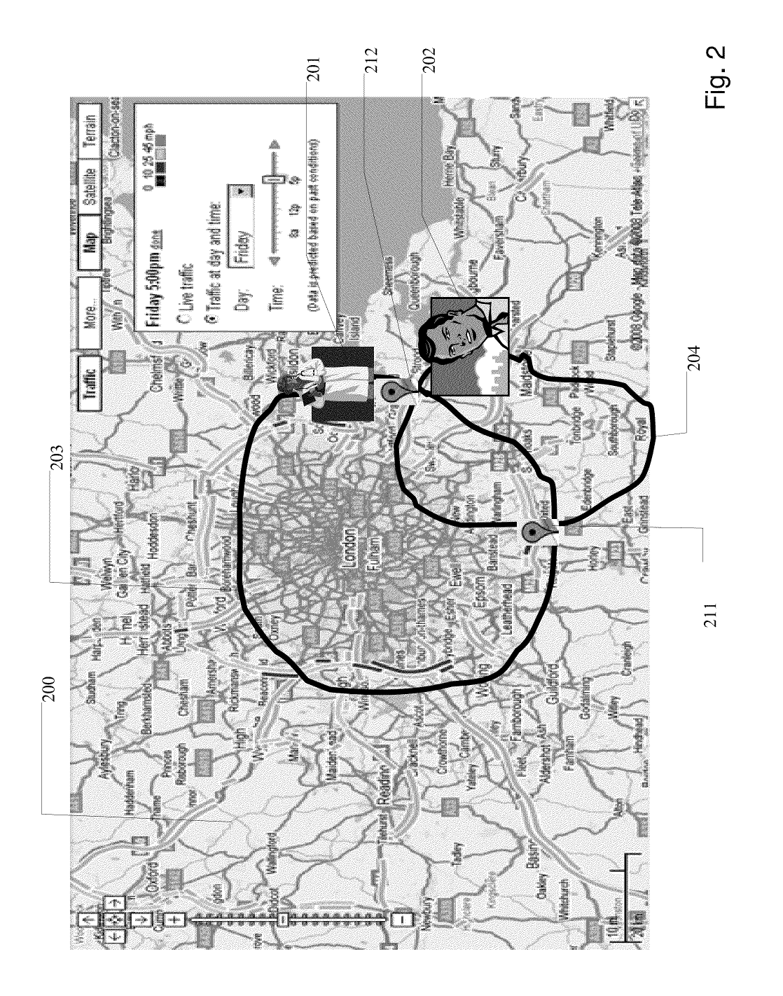

FIG. 2 shows the tracking graphs 203 and 204 of users 201 and 202. The two graphs intersect on the spot of 211 and 212. The routes can be further drawn on digital maps 200 where locations can also be associated or tagged with meaningful names, such as restaurants, schools, houses, companies, streets, parks and so on. For example, 211 may be a restaurant while 212 may be a shopping mall. Each track diagram can be represented either by one or a series of coordinates or location names and form a dynamically changing graphs.

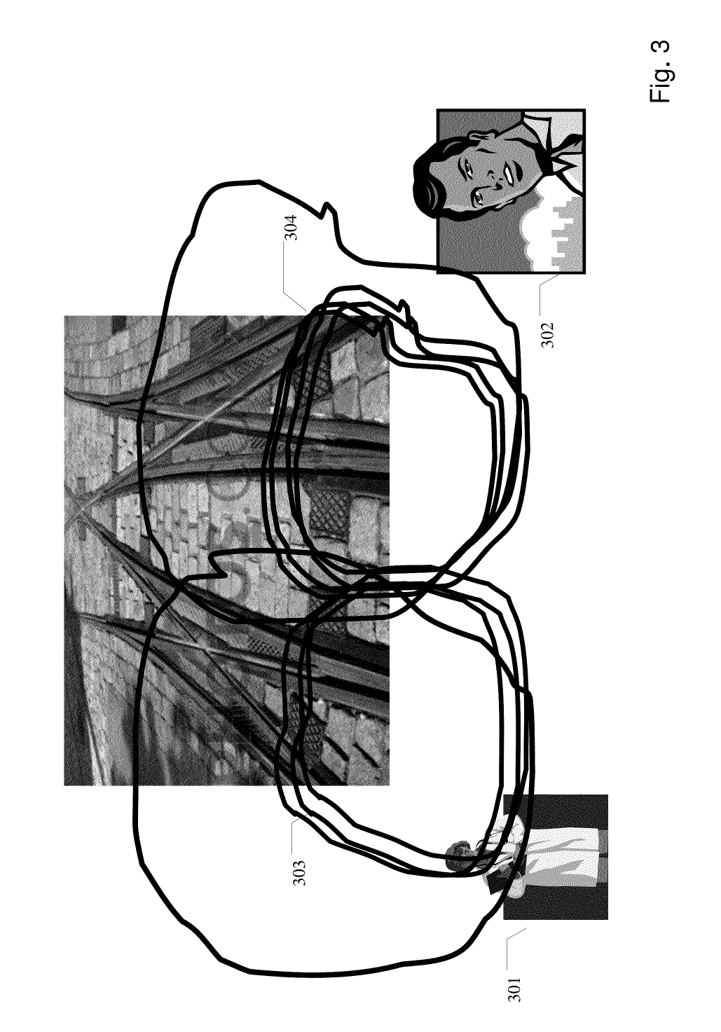

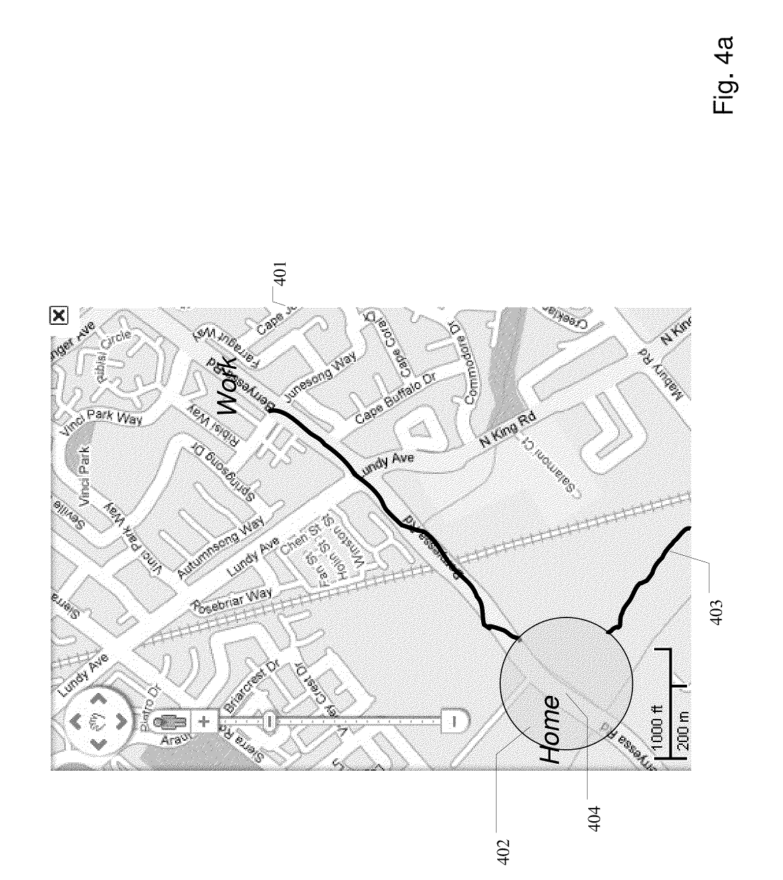

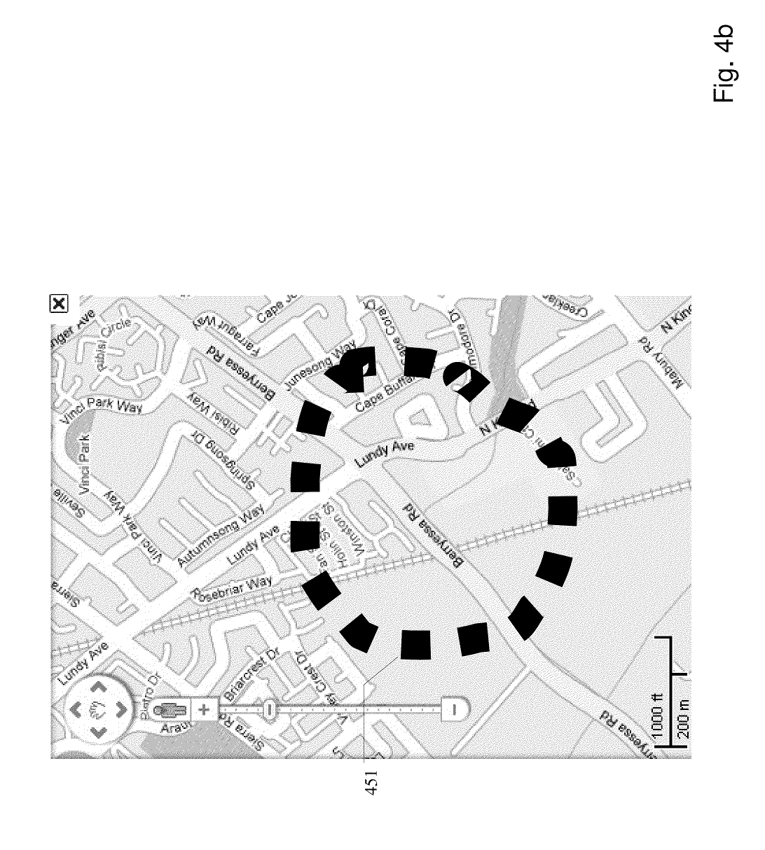

Knowing each person's tracking graph, the system can then compare the track graphs of all users to find how many intersections (FIGS. 2 211 and 212) among them. It can also find the best matching graphs in the system or most intersected graphs. For any two users, it can easily find the common geographical intersections between them. The search can be done either real time or offline. The number and intersections and the similarities between two tracking diagrams have significant values. As shown in FIG. 3, users 301 an 302's track/route graphs (303 and 304) intersect many times, some are on the same time, others are from different times. For instance, if two persons have lots of intersections between their daily route/track/trace graph, it definitively means that they shall have many things in common and it should be good to connect them together.

On the other hand, even two people do not intersect in their track diagrams; other properties in their diagram can reveal some similarities or associations between them. Even they does not live in the same city and there is no intersections, some intrinsic or hidden behaviors deep behind of the graph might be revealed if we measure the trace graph using different methods or metrics. For example, if two person's daily routes are both straight lines between work place and home, then both of them might have simple daily-lives split between work and family. If a person's graph constantly covers multiple cities or even countries, he has a very good chance to be a frequent traveler. A person who constantly appears in a night club might be unmarried while a person constantly stay home might be a family oriented person.

Using the trace/track/route graph, diagram, or data, the system can not only match two people not only based on the apparent similarities or attributes such as number of interactions there are, but also on the intrinsic or deep behind similarities between their life styles. Different life styles or personalities may project different brands on to the track graph and by analyzing the mapping among them the system can deduct many deep-level analysis and matching. One beauty of the system is that all the analysis can be performed automatically and silently, without the need for user input or intervene. Sometimes, the result of analysis may even beyond current user's awareness as it may reflect the subconsciousness or emotions. Furthermore, as soon as a user changes his behavior, his/her graph data will automatically reflects such changes. In most cases or for most users, the graph will reflect the user's true behavior as it is very hard for a person to fake or camouflage his own behavior for long time.

In addition to marching, the system can also automatically category users based on their location data or route graph. Traditional social networks usually ask user to manually add friends or contact lists as a way to build up one's social network, while in this system, when the system discovers similarities or associations between two people's route graph, it can categories the person based on them, such as frequented visited places or intrinsic attributes or behaviors derived from the route graph or location data. For example, a person who often visits sports center shall be an athlete or at least kind of sportsman/woman; another person walking between kindergartens and homes has more likelihood to be a housewife with small babies.

Automatically using this implicit or derived method to classify users into different groups can associate users with corresponding interest groups, or their true interests and behaviors. Thus, the system can be configured to use the history data to predict users' future needs, or what they might interest in the long run, even when they currently not aware of. For instance, the system might foresee that a housewife with small kids might need to select elementary schools pretty soon. When detected or discovered, those future events can be record in the system's internal database and can be further used to deduce additional inferences and have them recorded. At a later time or suitable time, the system can use those inferences or predictions to better serve the users, such as sending reminder messages, recommending relevant services or related advertisements. One example would be reminding and recommending a good elementary school to the mother on the beginning of the semester for the above mentioned sample.

Furthermore, one embodiment of the present application involves using the trace graph as a personal signature to express a user. As every user's trace/route graph is unique, the system can further create and update a picture of based on his daily location data or route graph and allow it been posted to the online photo album, or even profile page in other social networks to shown his personality. It can be posted as an image, photo, animated pictures or any other dynamically displayable visual representations that can show the users' location history. Through this way, a user can immediately notify all of his/her friends where he/she has visited recently and attract their interests without the need for the other parties to install client applications—any people who is viewing the profile image can see that changes when the picture is updated automatically.

For users in this system directly, a user using the system may also be able to see the current location data, track or trace graph of another user with the appropriate permissions. This way, a user has the ability to watch another person's location data changes in real time and sometimes can even guess or anticipate when his/her track will collide with his own route. It is also possible for him to leave or post a particular message to the projected location beforehand so that the other person can see it when he/she reaches there later.

Under this system, every action of a user can be monitored in real time, many additional applications and utilities can find wide usage on it. The system can provide notification mechanism to notify based on certain trigging events, such as: when a user leaves a place, passes by a particular location, stays still for a certain time, spends too much time in the road, goes too close to another user. Multiple or combinational events can also be used. As examples, legal authorities can use this system to monitor the activities of a criminal or suspect, parents can use it to watch for children, teachers can use it to look after students—so long as the monitoring is legal and privacy issues are resolved. For instance, parent can be notified if their little daughter goes too close to a forbidden place like night clubs.

The above methods can be further combined together to make a fun location based games for the users in the system as well as people in the external networks. While the system can enhance user interaction, it can also be a start point for users to improve their social lives. One of such example would be friends making and dating.

For example, if a college student sees and admires a girl multiple times in the same classroom, assuming both of them already signed up in the system, the boy can use the system to watch where the girls goes every day and hope to meet her in every places the next few days in order to pursue her.

In this scenario, privacy of a user shall also be considered and guarded to make sure it is not abused, otherwise, the girl may feel being monitored or unsafe using such a system. In this case, the system may use several different privacy protection mechanisms to ensure comfortableness for every user using this system while at the same time, encourages maximum freedom to share location data and information.

For example, the system may be configured to disallow any arbitrary user to simply open or access location data to any other user directly. This will greatly reduce worries for privacy and safety for average users. In addition, the system could allow users to setup rules to configure their own privacy settings, such as opening location data and trace graph to their friends, known people or other close circles.

As shown in FIG. 4a, inside the map 401 shows a user's route graph 403. However, when the user approaches his home 404 and, if he is within the area 402 (say, within 100-200 yards from his home 403), then his actual location data or route graph will be hidden to strangers from see it in the map.

Rules for strangers could be setup to require manual or explicit approval from location data owner before those-are-not-ones'-friends want to watch one's trace graph, or other location related data, such as where one is going, his or her trace/route graph etc. Another option could be a requirement that the stranger must already met with the target for certain times so he is no longer a complete stranger. Of course, a user could open his data to all so that everyone can view his/her whereabouts if he/she really wants anybody (like his/her followers or admires) to watch his/her track anonymously. Even in this case, the system may also show the current location of the watcher, following or pursuers also in the radar of the location owner, thus allowing the target knows exactly how many watchers/followers is currently following him/her and where they are at any time. In other words, if one wants to watch other people, you may also have to open yourself to him/her as well, which is a fair exchange and could enhance trust among people.

Another approach could be to add interference, obstruction or manual errors to the provided location data based on groups, like a followers' group based on level of familiarities to the user. For example, a rule could be set up that within a certain distance, say 100 yards, to the user's home or even all location datas when accessed by strangers, or friends with low familiarities. For example, in FIG. 4b, line 451 now becomes a dashed lines with wide width, which means others user cannot easily know the exact location of him/her.

Another rule could be that all location data shall be randomly shuffled or changed by 100 yards to any strangers. This way will greatly reduced the worry to leak sensitive and most important location data for users since those data are well protected from being traced accurately and users would feel more comfortable when dealing with pursuers.

Yet another approach is to add delays to the location data to further protect ones' privacy. For example, if a girl worries too much about her safety while still want to use the system to make more friends, she may choose to allow only old location data, such as where she had been some time ago, not where she is now, to the public. Through this rule, the system may add significant delay to the followers who is trying to watch her: 1 hour, or even 1 day. Then she shall be effectively protected from being monitored in real time and other users still have a chance to know where she had visited before and make. Such filtering or perturbation operations could be performed by either the server side or the client application. A user may also be able to fine tune the gratuity of the location data from the client application, for example, adjust the frequency the client application shall start to record the location data, by seconds, minutes, hours, or days.

Permissions to access and display location data for other people is another way of privacy and security protection. For example, before the system starts to record new location data, it may prompt a privacy dialog to the user and user may choose what data will be available to others. The permission and access rules may vary depending on the category of the other people.

In another embodiment of the present application, the system, including the client applications, could perform several steps to accelerate its spread among fans and make this new way of friend making more effective and more fun to use.

For example, the system could scan the contact list, call log and friend list in the user's device to see if any of his contact is also in the system, if yes, the user is immediately prompted to connect to them, allowing them to send messages, notifications or short messages to each other. In addition, the system may prompt the user to invite his/her friends in the contact list or call log by sending invitation messages or notification to join the system.

When the system is initially used, there may not be enough users, the system may automatically adjust the meaning of location terms such as “simultaneous”, “nearby”, “close” to show more people in a public map of the system. For instance, the meaning of “simultaneously presented at the same place” can be explained to “if two people were in the same location in the past 1 hour/2 hour/8 hour/1 day/1 week, they could be regarded as being met”. The advantage of doing this is to show and display more people when the system is small at the initial stage and gives users more chance to interact with more people. Of course, with time goes by and number of users continue to grow, this requirement can be automatically adjusted to become more strict and more limited. Otherwise, the user might see too many users.

Another aspect of the system could further enhance the interaction among users is to provide incentive for a user to invite more people to the system. For example, the system may provide online games, virtual goods, virtual items like points, medals or virtual ownerships which are earned through usage of the system. One unique incentive could be that a user is provided with certain “privileges” to watch and monitor any new user he/she brought or invited to the system.

For instance, if a college student fell in love with a girl at the first sight and wants to get more acquainted with her, he can invite her to join the system. As a reward, he may be given the privilege of as being the “No. 1 followers” to the girl. Among all followers, his name will always appear the first, in addition, he might get more accurate information about the girls' location data and has more chance to be connected to the girl if he is tied with another competitor. This will encourages people to introduce and bring more people to the system in able to achieve exponential growth of the users. Of course, the girl may still use the above mentioned privacy guidance to protect her own privacy.

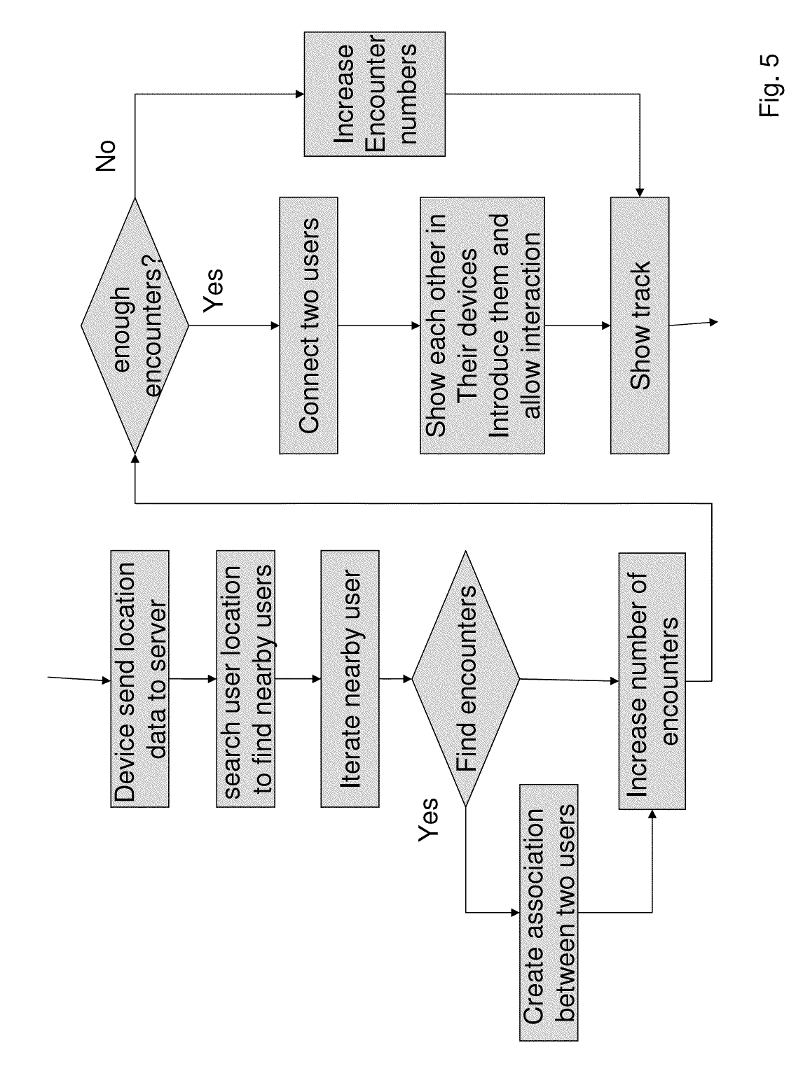

FIG. 5 shows a flowchart diagram of matching process that automatically connect two people together inside the system. This is just a brief illustration showing that two people will be introduced automatically after they have met enough times. The system will take care of maintaining their encounter counters without manual intervene. Users will be connected automatically after threshold being met.

This system can not only be used for online friends making or virtual dating, it can also be used in many other fields. For example, when a person arrives at a particular location, it is possible to search for information related to that location. Additional information related to his/her interests may also be presented, where those interests may be automatically categorized and determined by the system based on other users with similar track graph or life style. If a person spent most time in a kindergarten, he must have lots of interests with kids and children. If, on the other hand, a girl spent most time in department store, her interests might be fashions. As the system manages full details of all users location history and data, such as wherever the user has been, this system can more accurately deduct the person's behavior and interests based on the locations he went and other users who may have similar behaviors.

Furthermore, the system can deduct or infer common interests for a group of people who share similar life track based on similar route/track graph or other location data. Thus, it can provide much more accurate search results to better fits his/her requirement.

Let's illustrate this by one example. Assume a person visits a government office for some certificate paper work and the office usually requires a photo to be taken. While it is possible to search the Internet for such services through popular search provider such as Google, Yahoo or Microsoft, the research result might be too broad and most of them are unrelated. Instead, the system can perform a quick search among all other people who also visited the same government office (like DMV), and further searches all the photo shops among all places where those people have visited.

The search result shall be much more related because other users who also visited the same place should have higher possibilities to have encountered the same or similar problem—in this case, the need to get a picture. Thus their solution—a visit to a nearby photo shop shall be regarded as the better choice for a newcomer. This type of search based on location as well as other users is also more useful than simple local searches because the selections of other users, as a type of feedback, may already filter out those nearby service based on their quality and service, which are not commonly reflected by simple local searches.

In general, the system can not only provide search services for local information related to a location, but also search services among other users who have intersections with the current user after analysis of location data, track diagram, daily route and other associated information. In addition, the system can also provide a combined synthesized service that combines different types of services together. Users can further use the system to search any other things that does not have apparent connection or relationship with location. For example, a user can use this system to search for jobs and business opportunities. The success rate will still be higher than random search through traditional search engines as the system can search the same information among others who are either close to or having similar life styles with the current user. Furthermore, it is also possible for the system to record the search results for those people with similar interests and rank it higher with traditional search engine.

In order to provide such search service, the system or the server records places any user has visited and then aggregates the number of visits to each place for all users. This way, to the system can discover the hottest places a user has visited, or hottest places a group of people have visited. Moreover, search results can be listed or ordered by the visiting frequencies.

In the process of determining the exact place a user has just visited, the system may either manually prompt the user to select a place from within the system. Another alternative is to automatically marking the place a user just visited using location based sensor in the mobile device and compare it with an internal or online database. In addition, the system can also associate a user with various places by recording the time a user stays at a particular spot. The longer a user stays the stronger bonds between him/her with that place. This type of bond between a person to a location may be a signal or indicator of “fondness”, “love” or at least, familiarity to that place. This information can effectively used to filter out intermediate places that a user just passed by. As long as the user installed and started the mobile application to track his position, the system can always accurately recognized those more meaningful places by the time a user spent.

For example, if a user visits a new place and wants to query the system for directions or other information related to the current place, the system can immediately forward the question to another user who has spent the most time in that particular place as that person is most likely to be the one who is most familiar with that area. Then the system allows peer to peer communications and help among users. Another criteria for the system to use is to by looking up users' route graph. For example, a user who actively visiting surrounding areas is sometimes more experienced than another person who simply stays a place for long time without looking around.

In addition to provide searches to the user, the system can further be configured to provide advertisements or related information to the users based on the user's past experience, like places visited, or groups with similar track graph or life style. For example, if a person visits golf range every week, it is natural to send golf and sports related advertisements to him.

In other words, a user's life style deducted from his location data and track graph can be used as a means to determine the association and relationship between locations and advertisements. Typically, the more frequently a user visits a place, the more value an advertisement has when displayed at that place. Other information about the user can also be used to determine what kind of ads that he might have interests, like the other users he is currently looking after, monitoring, tracing or following. For example, even if a person does not go to a golf range himself but he is following a golf star, or another people who visits golf range a lot, the system shall infer that he should have interests on golf and sports to some degree.

In order to accurately measure the quantity of relationship between a user and an interest, the system may use a type of “association conduction” in the calculation. For example, if one person A goes to play golf every week, the interest score for golf is 100. B is A's friend, then B's interest score for golf will only be 30, as if 30% of the original score is been transmitted from A. Now if B now starts to follow C, who plays golf every day and having a score of 500, then 50% of C's score maybe conducted to B and now B has additional 250 interests score coming from C. Now B's total interests score is 30+250=280.

This is just an illustration and can be adjusted during real application. For example, a users visiting a places multiple times may multiple its interest score until it reaches a maximum limit. Different types of association may also have different conductivity coefficient which indicates how much interests is passed by from one person to another. One user may have different interests score for different topics and interests score can be further conducted to from one to another. Using this approach, it is very easy to calculate and quantify interest level among the very complex location data as well as route/track graphs.

Interests score can also be applied to a group of users which indicates the average or total interest level a group of user to a particular topic or subject. Once the system calculates the interest score of a user or a group, it can use that to push related information, advertisements or other services.

There are also multiple delivery methods for the system to deliver those services or information to the user. For instance, when a user moves or relocates to a new location, the client application may show the user ads or related information around that area, along with how many times other users has visited. Sometimes, the ads can be combined with coupons, or special promotions from nearby stores, so that the user can use it to reduce his cost for some merchandise or service. Other types of ads may be location unaware as they can be pushed to all interested users regardless of the location.

In this system, people are connected and can also exercise their knowledge, experience and can help each other. They can also proactively provide additional data sources, comments or recommendations to help each other. In reality, a new type of vertical search can be formed utilizing the wisdom of cloud to help during searching and selections

In yet another embodiment of the present application, the system may provide a virtual world for those who cannot try in real world. This differs from a real user who is walking in the street with a real device connected to the system in real time. For the later case, the user is “real”, while in this new case, the user is regarded as “virtual”. For example, if a user does not live in a particular city, but he still has some desire to make new friends in that city. In this case, the system can provide a new kind of “virtual experience” for those who want to simulate their lives through this system under new name. Another use case is to allow a user to try different life he missed in the past, for instance, attending in a particular college in the virtual world.

For instance, the system can provide a web page or web portal to for a web user to login and then virtually visit different places in the digital map, and leave his steps in this virtual map. Although he is not physically in that location, he can “virtually” meet with other users who are physically in that same location. It is a good way to encourage users to explore first before at their spare time before actually trying to use it in their daily lives.

Of course, in order to protect privacy and safety for real users, the system may distinguish such web or virtual users from real or physical users. For example, marking them with distinguishable icons or lowering their permissions and priorities is one remedy to be fair for those real users who are physically visiting and sharing their real experiences. However, the system may have the option to blur or hide such differences under rare circumstances, for example, by order of law enforcements or other reasons. Another option is to separate all virtual users from real users each having their own spaces.

No matter what methods are using, this approach gives anybody who is not able to physically to travel to a particular location a chance to enjoy the fun to connect to real users far away. It is a mixture of virtual location based service and real location based world. Without this system, it is hard for a handicapped or disabled to achieve the same effect in real world. Another example is that one can try to make friends with foreigners if he/she spends enough time within a foreign city in the digital maps.

That said, a person simply browses a map from a browser, plans an imaginary routes from place to place, and the system is able to simulate him within the digital map. Meanwhile, to attract users to visit it every day as if he is really a resident, the digital map may be shown with real scenes and even 3D or real visual effects while the user is moving within the digital maps. Same as a real user, a virtual user is also able to interact with other users, like viewing photos shared by other users and sharing own photos, ideas, comments with others as well as sending and receiving messages. The virtual tour and route of the virtual user can also be used to match with other users (real or virtual) for intersections and searching for common interests the same way. A virtual user is also able to watch his/her own track/route/trace graph as well as to connect to other social networks.

In other words, whether a person is online or offline, whether or not he is carrying a real device or just sitting behind a computer, any user shall have the ability to either physically share his real experience or share his virtually experience while browsing and watch a remote location. Two different exploration approaches are now merged into a single virtual space and share a single experience in the same way, all within one single system.

Furthermore, the system can also categories those virtual users and virtual locations as potential advertisement targets since those users exhibit a strong desire to visit such locations in the future. Thus the ads and information are very valuable and effective. For example, discounted airline tickets and travel packages can be pushed to those virtual users who constantly visit virtual places like Hawaii.

In summary, the system and methods disclosed in the present application utilize location based services to enhance more interactions between peoples. They allow shy and timid people more easily to connect to others in a more comfortable and easy way, without too much manual work and with minimal time expense. The system and methods also automatically calculate users' interests scores based on their location data, either directly or deducted, to help grouping users and connecting people together.

The system, methods and examples disclosed are just for illustration only and by no means for limitation. Although we use mobile devices as the primary subject, it shall not be regarded as limitation as well. With the development of technology, more and more devices and technologies could be used while the same principles disclosed here shall apply to them as well.

1. A method of using location based services to enhance user interactions, comprising the steps of:
recording a user location through a mobile device;
uploading user's location data to a central server;
analyzing users' interests from location data;
categorizing and grouping users based on the interests;

2. The method of claim 1, further comprising:
allowing a user to send messages and virtual items to another or on a particular location to be picked up by said receiver only when said receiver approaches said location.

3. The method of claim 1, further comprising:
generating a track graph for a user based on a user's location data.

4. The method of claim 3, further comprising:
automatically matching and connecting two users on a predefined threshold.

5. The method of claim 4, wherein:
said threshold associates to number intersections between said users.

6. The method of claim 4, wherein:
said threshold includes level of similarities, common behaviors and life styles.

7. The method of claim 1, further comprising:
displaying nearby users in a common digital map where the size of nearby area can be automatically adjusted based on number of users.

8. The method of claim 1, where analyzing users' interests from location data further comprising:
calculating a users interests score from a topic based on his location data.

9. The method of claim 3, further comprising:
allowing a user to use said trace graph as personal signature for self expression.

10. The method of 1, further comprising:
allowing a user to search for information related to that location from among users similar to his interests.

11. The method of claim 2, wherein:
said messages and virtual items contain various attributes and actions.

12. The method of claim 1, further comprising:
allowing a user to connect to external networks when location data is updated.

13. The method of claim 1, further comprising:
providing user privileges to watch and monitor activities of new users that are invited to the system by said user

14. A method of guarding and protecting privacy in location based service comprising the steps of:
collecting location data for a user;
sending location data to a central server for processing and sharing;
modifying location based data and information before sending and sharing to other users.

15. The method of claim 14, wherein modifying location based data and information further comprising:
hiding location based data and information when said user approaches certain locations.

16. The method of claim 14, wherein modifying location based data and information further comprising:
adding interference, obstruction or manual errors to the location data when said user approaches certain locations;

17. The method of claim 14, wherein modifying location based data and information further comprising:
adding time delays to said the location data when said user approaches certain locations;

18. A system of virtual world to provide location based services for both real and virtual world, comprising:
client side application in mobile devices to record users' location data and transfer to a central server;
central server to process data from each of said client applications, analyze users' interests and life styles, category and aggregate users based on said interests and styles; and
web applications for web users in the Internet to display location based data and track routes in digital maps.

19. The system of claim 18, wherein said web applications is further configured to:
allow web users to visit different places virtually by browsing said digital maps through imaginary routes.

20. The system of claim 18, further comprising:
client side components and web components to allow web users to interact with real users as if they were real users.
